(19) United States
(12) Patent Application Publication
(10) Pub. No.: US 2023/0091423 A1
(43) Pub. Date: Mar. 23, 2023

(54) METHOD OF DISPLAYING IMAGE, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Xuexing ZHENG, Beijing (CN); Dong Yao, Beijing (CN); Ruizhi Chen, Beijing (CN); Hao Guo, Beijing (CN)

(73) Assignee: BEIJING BAIDU NETCOM SCIENCE TECHNOLOGY CO., LTD., Beijing (CN)

(21) Appl. No.: 17/991,248

(22) Filed: Nov. 21, 2022

(30) Foreign Application Priority Data
Nov. 22, 2021 (CN) 202111390361.8

(51) Int. Cl. G06T 19/20; G06T 15/00

(52) U.S. Cl. CPC G06T 19/20; G06T 15/00; G06T 2219/2012; G06T 2219/2021; G06T 2219/2016

(57) ABSTRACT

A method of displaying an image, an electronic device, and a storage medium, which relate to an image processing field, in particular to fields of a three-dimensional display technology and a computer graphics technology, and are applied to augmented reality, virtual reality, mixed reality or other scenarios. The method includes: obtaining an adjusted parameter value in response to a triggering operation of an editing control for a parameter item to be adjusted; generating a three-dimensional avatar related to a target image, based on the adjusted parameter value, three-dimensional model data, and target image data of the target image; generating a preview image of the three-dimensional avatar according to the three-dimensional avatar; and displaying the three-dimensional avatar by using the adjusted parameter value, in response to a determination that a preview effect of the preview image meets an expected effect.

This application claims priority to Chinese Patent Application No. 202111390361.8, filed on Nov. 22, 2021, which is incorporated herein in its entirety by reference.

### TECHNICAL FIELD

The present disclosure relates to a field of image processing technology, in particular to fields of a three-dimensional display technology and a computer graphics technology, and may be applied to scenarios such as augmented reality, virtual reality, mixed reality or the like. Specifically, the present disclosure relates to a method of displaying an image, an electronic device, and a storage medium.

### BACKGROUND

With the development of three-dimensional display technology and computer graphics technology, more and more entertainment and convenience are brought to objects. A three-dimensional avatar is an application based on three-dimensional display technology and computer graphics technology. The three-dimensional avatar is widely used in character modeling scenarios, such as social networking, live streaming, games or the like.

### SUMMARY

The present disclosure provides a method of displaying an image, an electronic device, and a storage medium.

According to an aspect of the present disclosure, a method of displaying an image is provided, including: obtaining an adjusted parameter value in response to a triggering operation of an editing control for a parameter item to be adjusted; generating a three-dimensional avatar related to a target image, based on the adjusted parameter value, three-dimensional model data, and target image data of the target image; generating a preview image of the three-dimensional avatar according to the three-dimensional avatar; and displaying the three-dimensional avatar by using the adjusted parameter value, in response to a determination that a preview effect of the preview image meets an expected effect.

According to an aspect of the present disclosure, an electronic device is provided, including: at least one processor; and a memory communicatively connected to the at least one processor, wherein the memory stores instructions executable by the at least one processor, and the instructions, when executed by the at least one processor, cause the at least one processor to implement a method described herein.

According to an aspect of the present disclosure, a non-transitory computer-readable storage medium having computer instructions therein is provided, and the computer instructions are configured to cause a computer system to implement a method described herein.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, in which:

FIG. 1 schematically shows an exemplary system architecture to which a method of displaying an image and an apparatus of displaying an image may be applied according to embodiments of the present disclosure;

FIG. 2 schematically shows a flowchart of a method of displaying an image according to embodiments of the present disclosure;

FIG. 3 schematically shows a flowchart of a method of displaying an image according to other embodiments of the present disclosure;

FIG. 4 schematically shows an example diagram of an image display effect according to embodiments of the present disclosure;

FIG. 5 schematically shows a block diagram of an apparatus of displaying an image according to embodiments of the present disclosure; and

FIG. 6 schematically shows a block diagram of an electronic device suitable for implementing a method of displaying an image according to embodiments of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those of ordinary skilled in the art should realize that various changes and modifications may be made to embodiments described herein without departing from the scope and spirit of the present disclosure. Likewise, for clarity and conciseness, descriptions of well-known functions and structures are omitted in the following descriptions.

A three-dimensional avatar may refer to an avatar generated using a three-dimensional display technology and a computer graphics technology. The three-dimensional avatar may interact with an object in a three-dimensional display manner.

In a process of generating the three-dimensional avatar, if a generation effect of the three-dimensional avatar does not meet an expected generation effect, it is needed to adjust a parameter value of a parameter item to be adjusted, so as to generate a three-dimensional avatar that meets the expected generation effect. A large number of parameter items are related to the three-dimensional avatar, and the number of parameter items may reach hundreds. The parameter values of the parameter items related to the three-dimensional avatar may be stored in a parameter table.

A solution of performing an image display in a manual mode may be used, that is, if it is needed to adjust a parameter value of a parameter item to be adjusted, the parameter value of the parameter item to be adjusted in the parameter table may be manually adjusted by an object. After an adjusted parameter value is obtained, it is needed to manually trigger an operation of generating a three-dimensional avatar. That is, in response to an operation instruction for generating a three-dimensional avatar input by the object, a three-dimensional avatar related to a target image may be generated using the adjusted parameter value, three-dimensional model data, and target image data of the target image. After the three-dimensional avatar is generated, it is needed to manually trigger an operation of displaying the three-dimensional avatar. That is, in response to an operation instruction for displaying the three-dimensional avatar input by the object, the three-dimensional avatar is updated to a rendering engine, then the rendering engine is sent to a display terminal, and the three-dimensional avatar is rendered using the rendering engine, so as to generate a preview image. If a preview effect of the preview image does not meet an expected effect of the object, it is needed to repeatedly perform the above-mentioned operations until the expected effect of the object is met.

An adjustment operation of the parameter value in the above solution is complicated, which affects an efficiency of a parameter adjustment. In addition, since the rendering engine needs to be packaged to the display terminal, it is difficult to intuitively obtain the generation effect of the three-dimensional avatar in real time.

Therefore, embodiments of the present disclosure provide an image display solution. It is possible to obtain an adjusted parameter value in response to a triggering operation of an editing control for a parameter item to be adjusted. A three-dimensional avatar related to a target image may be generated based on the adjusted parameter value, three-dimensional model data, and target image data of the target image. A preview image of the three-dimensional avatar may be generated according to the three-dimensional avatar. When it is determined that a preview effect of the preview image meets an expected effect, the three-dimensional avatar may be displayed using the adjusted parameter value.

The parameter value is adjusted using the editing control, so that a complexity of the adjustment of the parameter value is reduced. The three-dimensional avatar related to the target image is generated based on the adjusted parameter value, the three-dimensional model data and the target image data of the target image, the preview image of the three-dimensional avatar is generated according to the three-dimensional avatar, and the three-dimensional avatar is displayed using the adjusted parameter value when it is determined that the preview effect of the preview image meets the expected effect, so that an automation of the parameter adjustment and a real-time preview of the parameter adjustment effect are achieved, and the efficiency of the parameter adjustment is improved.

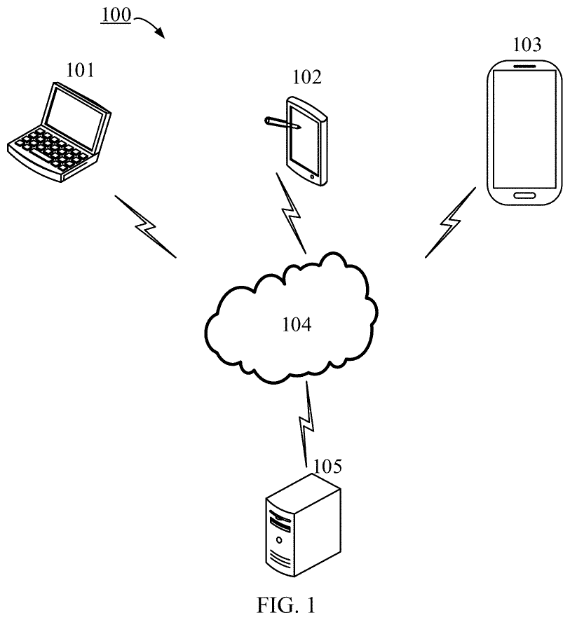

FIG. 1 schematically shows an exemplary system architecture to which a method of displaying an image and an apparatus of displaying an image may be applied according to embodiments of the present disclosure.

It should be noted that FIG. 1 is merely an example of the system architecture to which embodiments of the present disclosure may be applied to help those skilled in the art understand the technical content of the present disclosure, but it does not mean that embodiments of the present disclosure may not be applied to other devices, systems, environments or scenarios. For example, in other embodiments, an exemplary system architecture to which a method of displaying an image and an apparatus of displaying an image may be applied may include a terminal device, but the terminal device may implement the method of displaying the image and the apparatus of displaying the image provided by embodiments of the present disclosure without interacting with a server.

As shown in FIG. 1, a system architecture 100 according to such embodiments may include terminal devices 101, 102 and 103, a network 104, and a server 105. The network 104 is a medium for providing a communication link between the terminal devices 101, 102, 103 and the server 105. The network 104 may include various connection types, such as wired and/or wireless communication links, or the like.

The terminal devices 101, 102 and 103 may be used by a user to interact with the server 105 through the network 104 to receive or send messages or the like. The terminal devices 101, 102 and 103 may be installed with various communication client applications, such as knowledge reading applications, web browser applications, search applications, instant messaging tools, email clients and/or social platform software, etc. (for example only).

The terminal devices 101, 102 and 103 may be various electronic devices having display screens and supporting web browsing, including but not limited to smart phones, tablet computers, laptop computers, desktop computers, or the like.

The server 105 may be a server providing various services, such as a background management server (for example only) that provides a support for a content browsed by the user using the terminal devices 101, 102 and 103. The background management server may analyze and process received data such as a user request, and feed back a processing result (such as a web page, an information, or data acquired or generated according to the user request) to the terminal devices.

The server 105 may be a cloud server, also known as a cloud computing server or a cloud host, which is a host product in a cloud computing service system to solve shortcomings of difficult management and weak service scalability existing in an existing physical host and VPS (Virtual Private Server) service. The server 105 may also be a server of a distributed system or a server combined with a block-chain.

It should be noted that the method of displaying the image provided by embodiments of the present disclosure may generally be performed by the server 105. Accordingly, the apparatus of displaying the image provided by embodiments of the present disclosure may be generally provided in the server 105. The method of displaying the image provided by embodiments of the present disclosure may also be performed by a server or server cluster different from the server 105 and capable of communicating with the terminal device 101, 102, 103 and/or the server 105. Accordingly, the apparatus of displaying the image provided by embodiments of the present disclosure may also be provided in a server or server cluster different from the server 105 and capable of communicating with the terminal device 101, 102, 103 and/or the server 105.

Alternatively, the method of displaying the image provided by embodiments of the present disclosure may generally be performed by the terminal device 101, 102 or 103. Accordingly, the apparatus of displaying the image provided by embodiments of the present disclosure may be provided in the terminal device 101, 102 or 103.

It should be understood that the number of the terminal devices, the network and the server shown in FIG. 1 are merely schematic. According to implementation needs, any number of terminal device, network and server may be provided.

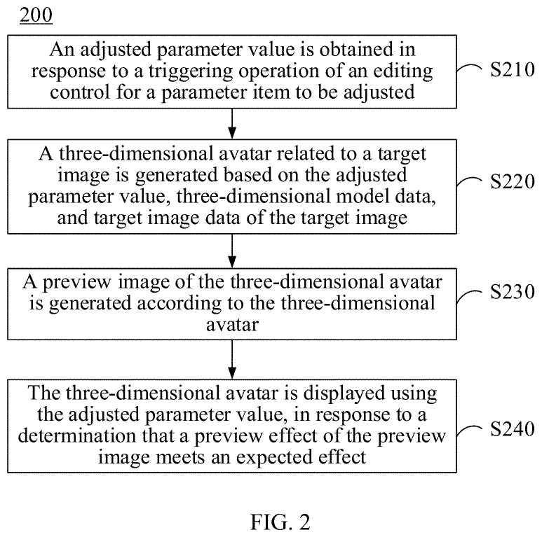

FIG. 2 schematically shows a flowchart of a method of displaying an image according to embodiments of the present disclosure.

As shown in FIG. 2, a method 200 includes operation S210 to operation S240.

In operation S210, an adjusted parameter value is obtained in response to a triggering operation of an editing control for a parameter item to be adjusted.

In operation S220, a three-dimensional avatar related to a target image is generated based on the adjusted parameter value, three-dimensional model data, and target image data of the target image.

In operation S230, a preview image of the three-dimensional avatar is generated according to the three-dimensional avatar.

In operation S240, the three-dimensional avatar is displayed using the adjusted parameter value, in response to a determination that a preview effect of the preview image meets an expected effect.

According to embodiments of the present disclosure, the parameter item may refer to a parameter item related to an image of an object. The parameter item may include at least one selected from: a part parameter item, a decoration parameter item, or a posture parameter item. The part parameter item may include at least one selected from: a head parameter item, a neck parameter item, a chest parameter item, or a limb parameter item. The head parameter item may include at least one selected from: an eyebrow parameter item, an eye parameter item, an ear parameter item, a nose parameter item, a mouth parameter item, a brain parameter item, or the like. Each part parameter item may include at least one selected from: a part size, a part color, a part shape, or the like. The decoration parameter item may include at least one selected from: a clothing parameter item, an accessory parameter item, or the like. The posture parameter item may include at least one selected from: an action parameter item, an expression parameter item, or the like.

According to embodiments of the present disclosure, each parameter item may have a parameter value corresponding to the parameter item. The parameter item to be adjusted may refer to a parameter item that needs to be adjusted.

According to embodiments of the present disclosure, the editing control may refer to a visual control for implementing an editing operation. The editing operation may be used to adjust the parameter value of the parameter item. The editing control may be provided on a visual edit page. One editing control may implement one or more functions. The editing operation may include at least one selected from: an adding operation, a modifying operation, a deletion operation, a sorting operation, a grouping operation, or the like. Accordingly, the editing control may include at least one selected from: an adding control, a modifying control, a deleting control, a sorting control, or a grouping control. A form of the editing operation may be configured according to actual service requirements, and is not limited here. For example, the form of the editing operation may include at least one selected from scaling, rotating, cutting, stitching, dragging, entering, or selecting. The form of the editing control may be configured according to actual service requirements, and is not limited here. For example, the form of the editing control may include a slider control. The slider control may include a sliding bar and a sliding block. The sliding block is arranged on the sliding bar, and the parameter item may be adjusted by dragging the sliding block on the sliding bar. Different positions of the sliding block on the sliding bar represent different parameter values of the parameter item.

According to embodiments of the present disclosure, the triggering operation may refer to an operation of generating an adjustment instruction. The triggering operation may include at least one selected from: a confirmation operation, or an operation of an operator leaving the edit page.

According to embodiments of the present disclosure, the three-dimensional model data may refer to model data of a three-dimensional model used to generate the three-dimensional avatar. The three-dimensional model may include various types of models. For example, the three-dimensional model may include a humanoid model, an animal model, a plant model, or other models. Other models may include at least one selected from: a living goods model, a work goods model, a learning goods model, a traffic goods model, or the like. The target image may include a target object. The preview image may be an image used to preview the generated three-dimensional avatar.

According to embodiments of the present disclosure, the preview effect may be used to represent an effect of the generated three-dimensional avatar. The expected effect may refer to a desired effect of the three-dimensional avatar. The expected effect may be used as a criterion for measuring whether the generated three-dimensional avatar meets requirements. The preview effect may be determined according to an evaluation index value of image quality of the preview image (the evaluation index value may refer to a value for measuring the image quality, and the evaluation index value of image quality may also be called the index value of the image quality). The expected effect may be determined according to an expected evaluation index value of image quality.

According to embodiments of the present disclosure, an editing request may be acquired, and the editing request may include an adjusted parameter value for the parameter item to be adjusted. The editing control corresponding to the parameter item to be adjusted may be called in response to the editing request. The parameter value of the parameter item to be adjusted may be adjusted by using the editing control, and a triggering operation may be generated when the adjustment of the parameter value of the parameter item to be adjusted is completed. The adjusted parameter value may be obtained in response to the triggering operation for the parameter item to be adjusted.

According to embodiments of the present disclosure, after the adjusted parameter value is obtained, it is possible to process the adjusted parameter value, the three-dimensional model data, and the target image data of the target image using a three-dimensional avatar generation algorithm, so as to generate a three-dimensional avatar related to the target image.

According to embodiments of the present disclosure, after the three-dimensional avatar is obtained, it is possible to process the three-dimensional avatar using a rendering engine to generate a preview image of the three-dimensional avatar. It may be determined whether a preview effect of the preview image meets an expected effect. If it is determined that the preview effect of the preview image meets the expected effect, the adjusted parameter value may be determined as a target parameter value. Then the three-dimensional avatar generated using the adjusted parameter value may be displayed.

According to embodiments of the present disclosure, the parameter value is adjusted using the editing control, so that a complexity of the adjustment of the parameter value is reduced. The three-dimensional avatar related to the target image is generated based on the adjusted parameter value, the three-dimensional model data and the target image data of the target image, the preview image of the three-dimensional avatar is generated according to the three-dimensional avatar, and the three-dimensional avatar is displayed using the adjusted parameter value when it is determined that the preview effect of the preview image meets the expected effect, so that an automation of the parameter adjustment and a real-time preview of the parameter adjustment effect are achieved, and the efficiency of the parameter adjustment is improved.

According to embodiments of the present disclosure, the above-mentioned method of displaying the image may further include the following operations.

When it is determined that the preview effect of the preview image does not meet the expected effect, the following operations may be performed repeatedly until a preview effect of a new preview image meets the expected effect.

A new adjusted parameter value is obtained in response to the triggering operation of the editing control for the parameter item to be adjusted. A new three-dimensional avatar related to the target image is generated based on the new adjusted parameter value, the three-dimensional model data and the target image data of the target image. A new preview image of the new three-dimensional avatar is generated according to the new three-dimensional avatar. It is determined whether the preview effect of the new preview image meets the expected effect.

According to embodiments of the present disclosure, if it is determined that the preview effect of the preview image does not meet the expected effect, the operation of obtaining a new adjusted parameter value, the operation of generating a new three-dimensional avatar, the operation of generating a new preview image and the operation of determining whether the preview effect of the new preview image meets the expected effect may be performed repeatedly until it is determined that the preview effect of the new preview image meets the expected effect.

According to embodiments of the present disclosure, the above-mentioned method of displaying the image may further include the following operations.

A parameter value corresponding to the parameter item to be adjusted in a parameter configuration file is updated according to the adjusted parameter value, so as to obtain an updated parameter configuration file.

According to embodiments of the present disclosure, the operation S220 may include the following operations.

The three-dimensional model data and the target image data of the target image are processed based on a set of scene function files, so as to generate the three-dimensional avatar related to the target image. The set of scene function files includes a relevant file for implementing a scene function, and the relevant file includes the updated parameter configuration file.

According to embodiments of the present disclosure, the parameter configuration file may be used to store the parameter value of the parameter item. A file format of the parameter configuration file may be configured according to actual service requirements, which is not limited here. For example, the file format of the parameter configuration file may include JSON (JavaScript Object Notation) or XML (Extensible Markup Language). At least one of functions of creating, exporting, secondary importing the parameter configuration file may be supported.

The set of scene function files may include a plurality of relevant files. The relevant files included in the set of scene function files may be files related to an implementation of the scene function. For example, the set of scene function files may include relevant files for implementing the image display solution described in embodiments of the present disclosure. The relevant files may include at least one selected from: a parameter configuration file, a scene configuration file, a model file, a script file, or a texture file. The script file may be a script file based on Lua script language. The script file may include files for implementing the three-dimensional avatar generation algorithm, the preview image of the three-dimensional avatar, and the display of the three-dimensional avatar. A file format of the scene configuration file may be JSON. A file format of the model file may include at least one selected from: FBX (FilmBoX) or gITF (GL transmission format). The texture file may be used to describe an appearance of the three-dimensional model. A file format of the texture file may include at least one selected from: PNG (Portable Network Graphics), JPG, JPEG (Joint Photographic Experts Group), KTX, or BMP (Bitmap).

According to embodiments of the present disclosure, the three-dimensional model data and the target image data may be processed using the set of scene function files, so as to generate the three-dimensional avatar related to the target image.

According to embodiments of the present disclosure, the operation S230 may include the following operations.

The three-dimensional avatar is rendered using a rendering engine based on the set of scene function files, so as to generate the preview image of the three-dimensional avatar.

According to embodiments of the present disclosure, a relevant file related to a rendering function in the set of scene function files may be called using the rendering engine, and the three-dimensional avatar may be rendered using the relevant file related to the rendering function, so as to generate the preview image of the three-dimensional avatar.

According to embodiments of the present disclosure, the above-mentioned method of displaying the image may further include the following operations.

The preview effect of the preview image is determined according to an evaluation index value of image quality of the preview image. The evaluation index value of image quality includes at least one selected from: a pixel mean value, a pixel standard deviation, a pixel average gradient, or image entropy.

According to embodiments of the present disclosure, the evaluation index value of image quality may be used as a criterion for measuring an effect of the preview image. The evaluation index value of image quality may include at least one selected from a pixel mean value, a pixel standard deviation, a pixel average gradient, or image entropy. The pixel mean value may refer to an average value of pixel values of pixel points in an image. The pixel mean value may reflect an average brightness of the image. The pixel standard deviation may refer to a degree of dispersion of the pixel values in the image relative to the pixel mean value. The pixel standard deviation may reflect the degree of dispersion of the pixel values in the image. The pixel average gradient may reflect a detail contrast and a texture transformation in the image, which may reflect a clarity of the image, that is, the pixel average gradient may reflect the clarity of the image. The image entropy may refer to a bit average value of a set of image gray levels. The image entropy describes an average amount of information of an image information source.

According to embodiments of the present disclosure, the larger the pixel mean value, the larger the average brightness of the image, and the higher the image quality. The larger the pixel standard deviation, the more dispersed the distribution of pixel values in the image, and the higher the image quality. The larger the pixel average gradient, the higher the image clarity, that is, the higher the image quality.

According to embodiments of the present disclosure, determining the preview effect of the preview image according to the evaluation index value of image quality of the preview image may include the following operations.

In a case that the evaluation index value of image quality of the preview image falls within an expected evaluation index range, it is determined that the preview effect of the preview image meets the expected effect. In a case that the evaluation index value of image quality of the preview image does not fall within the expected evaluation index range, it is determined that the preview effect of the preview image does not meet the expected effect.

According to embodiments of the present disclosure, the expected effect may be represented by the expected evaluation index range. If the image quality index evaluation value falls within the expected evaluation index range, it may be determined that the preview effect of the preview image meets the expected effect. If the image quality index evaluation value does not fall within the expected evaluation index range, it may be determined that the preview effect of the preview image does not meet the expected effect.

According to embodiments of the present disclosure, if the preview effect may be determined by using a plurality of evaluation index values of image quality, it may be determined that the preview effect of the preview image meets the expected effect in a case that the plurality of evaluation index values of image quality fall within respective expected evaluation index ranges. It may also be determined that the preview effect of the preview image meets the expected effect in a case that some evaluation index values of image quality among the plurality of evaluation index values of image quality fall within respective expected evaluation index ranges. A number of some evaluation index values of image quality among the plurality of evaluation index values of image quality may be greater than or equal to a number threshold.

For example, the evaluation index values of image quality may include a pixel mean value, a pixel standard deviation, and a pixel average gradient.

The expected evaluation index ranges may include a pixel mean value range, a pixel standard deviation range, and a pixel average gradient range.

Determining the preview effect of the preview image according to the evaluation index values of image quality of the preview image may include at least one selected from: determining that the preview effect meets the expected effect if the pixel mean value of the preview image falls within the pixel mean value range; determining that the preview effect meets the expected effect if the pixel standard deviation of the preview image falls within the pixel standard deviation range; or determining that the preview effect meets the expected effect if the pixel average gradient of the preview image falls within the pixel average gradient range.

According to embodiments of the present disclosure, the editing control may include at least one selected from: an adding control, a modifying control, a deleting control, a sorting control, or a grouping control.

According to embodiments of the present disclosure, the adding control may be used to create a new parameter item. The modifying control may be used to modify a parameter value of a parameter item. The deleting control may be used to delete a parameter item. The sorting control may be used to sort levels of different parameter items. The grouping control may be used to adjust the grouping of parameter items.

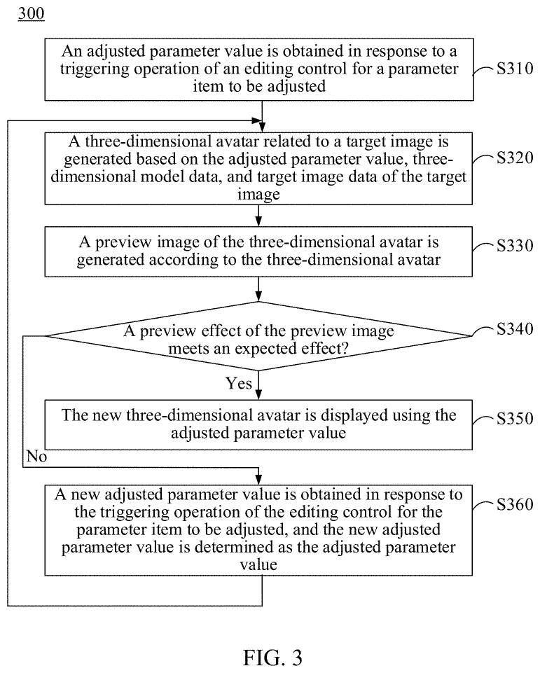

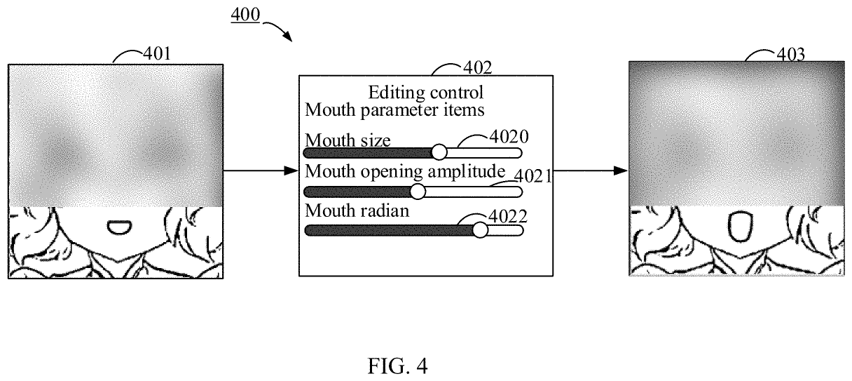

The method of displaying the image according to embodiments of the present disclosure will be further described with reference to FIG. 3 to FIG. 4 in combination with specific embodiments.

FIG. 3 schematically shows a flowchart of a method of displaying an image according to other embodiments of the present disclosure.

As shown in FIG. 3, a method 300 includes operation S310 to operation S360.

In operation S310, an adjusted parameter value is obtained in response to a triggering operation of an editing control for a parameter item to be adjusted.

In operation S320, a three-dimensional avatar related to a target image is generated based on the adjusted parameter value, three-dimensional model data, and target image data of the target image.

In operation S330, a preview image of the three-dimensional avatar is generated according to the three-dimensional avatar.

In operation S340, it is determined whether a preview effect of the preview image meets an expected effect or not, if yes, operation S350 is performed; and if not, operation S360 is performed.

In operation S350, the three-dimensional avatar is displayed using the adjusted parameter value.

In operation S360, a new adjusted parameter value is obtained in response to the triggering operation of the editing control for the parameter item to be adjusted, the new adjusted parameter value is determined as the adjusted parameter value, and performing the operation S320.

FIG. 4 schematically shows an example diagram of an image display effect according to embodiments of the present disclosure.

As shown in FIG. 4, in 400, mouth parameter items may include a mouth size, a mouth opening amplitude, and a mouth radian. Editing controls 402 may include a mouth size control 4020, a mouth opening amplitude control 4021, and a mouth radian control 4022. The editing control 402 may be in a form of a slider control. The slider control may include a sliding block and a sliding bar. The parameter items to be adjusted include the mouth opening amplitude and the mouth radian in the mouth parameter items. Accordingly, the editing controls corresponding to the parameter items to be adjusted include the mouth opening amplitude control 4021 and the mouth radian control 4022.

In a case that it is determined that a preview effect of a preview image 401 of the three-dimensional avatar does not meet the expected effect, the mouth opening amplitude may be adjusted by sliding on the sliding bar of the mouth opening amplitude control 4021, so as to obtain a new adjusted mouth opening amplitude value. The mouth radian may be adjusted by sliding on the sliding bar of the mouth radian control 4022, so as to obtain a new adjusted mouth radian value. A new three-dimensional avatar related to the target image may be obtained based on the new adjusted mouth opening amplitude value, the new adjusted mouth radian value, the three-dimensional model data and the target image data of the target image. A new preview image 403 of the new three-dimensional avatar may be generated according to the new three-dimensional avatar.

When it is determined that the preview effect of the new preview image 403 meets the expected effect, the three-dimensional avatar corresponding to the new preview image 403 is displayed using the new adjusted mouth opening amplitude value and mouth radian value.

In the technical solution of the present disclosure, the collection, storage, use, processing, transmission, provision, disclosure and application of user's personal information involved are all in compliance with the provisions of relevant laws and regulations, and necessary confidentiality measures have been taken, and it does not violate public order and good morals. In the technical solution of the present disclosure, before obtaining or collecting the user's personal information, the user's authorization or consent is obtained.

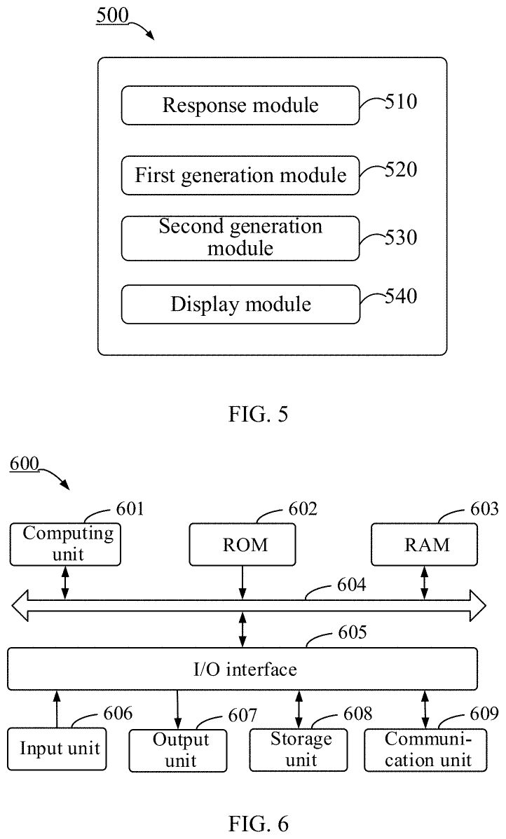

FIG. 5 schematically shows a block diagram of an apparatus of displaying an image according to embodiments of the present disclosure.

As shown in FIG. 5, an apparatus 500 of displaying an image may include a response module 510, a first generation module 520, a second generation module 530, and a display module 540.

The response module 510 may be used to obtain an adjusted parameter value in response to a triggering operation of an editing control for a parameter item to be adjusted.

The first generation module 520 may be used to generate a three-dimensional avatar related to a target image, based on the adjusted parameter value, three-dimensional model data, and target image data of the target image.

The second generation module 530 may be used to generate a preview image of the three-dimensional avatar according to the three-dimensional avatar.

The display module 540 may be used to display the three-dimensional avatar by using the adjusted parameter value, in response to a determination that a preview effect of the preview image meets an expected effect.

According to embodiments of the present disclosure, the apparatus 500 of displaying the image may be further used to: repeatedly perform operations until a preview effect of a new preview image meets the expected effect, in response to a determination that the preview effect of the preview image does not meet the expected effect. The operations include: obtaining a new adjusted parameter value in response to the triggering operation of the editing control for the parameter item to be adjusted; generating a new three-dimensional avatar related to the target image, based on the new adjusted parameter value, the three-dimensional model data, and the target image data of the target image; generating a new preview image of the new three-dimensional avatar according to the new three-dimensional avatar; and determining whether the preview effect of the new preview image meets the expected effect or not.

According to embodiments of the present disclosure, the apparatus 500 of displaying the image may further include an update module.

The update module may be used to update, according to the adjusted parameter value, a parameter value corresponding to the parameter item to be adjusted in a parameter configuration file, so as to obtain an updated parameter configuration file;

According to embodiments of the present disclosure, the first generation module 520 may include a first generation sub-module.

The first generation sub-module may be used to process the three-dimensional model data and the target image data of the target image based on a set of scene function files and the updated parameter configuration file, so as to generate the three-dimensional avatar related to the target image. The set of scene function files includes a relevant file for implementing a scene function.

According to embodiments of the present disclosure, the second generation module 530 may include a second generation sub-module.

The second generation sub-module may be used to render, by using a rendering engine, the three-dimensional avatar based on the set of scene function files, so as to generate the preview image of the three-dimensional avatar.

According to embodiments of the present disclosure, the apparatus 500 of generating the image may further include a determination module.

The determination module may be used to determine the preview effect of the preview image according to an evaluation index value of image quality of the preview image. The evaluation index value of image quality includes at least one selected from: a pixel mean value, a pixel standard deviation, a pixel average gradient, or image entropy.

According to embodiments of the present disclosure, the determination module may include a first determination sub-module and a second determination sub-module.

The first determination sub-module may be used to determine that the preview effect of the preview image meets the expected effect, in response to a determination that the evaluation index value of image quality of the preview image falls within an expected evaluation index range.

The second determination sub-module may be used to determine that the preview effect of the preview image does not meet the expected effect, in response to a determination that the evaluation index value of image quality of the preview image does not fall within the expected evaluation index range.

According to embodiments of the present disclosure, the editing control includes at least one selected from: an adding control, a modifying control, a deleting control, a sorting control, or a grouping control.

According to embodiments of the present disclosure, the present disclosure further provides an electronic device, a readable storage medium, and a computer program product.

According to embodiments of the present disclosure, an electronic device is provided, including: at least one processor; and a memory communicatively connected to the at least one processor. The memory stores instructions executable by the at least one processor, and the instructions, when executed by the at least one processor, cause the at least one processor to implement the method described above.

According to embodiments of the present disclosure, a non-transitory computer-readable storage medium having computer instructions therein is provided, and the computer instructions are configured to cause a computer to implement the method described above.

According to embodiments of the present disclosure, a computer program product containing a computer program is provided, and the computer program, when executed by a processor, causes the processor to implement the method described above.

FIG. 6 schematically shows a block diagram of an electronic device suitable for implementing the method of displaying the image according to embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 6, the electronic device 600 includes a computing unit 601 which may perform various appropriate actions and processes according to a computer program stored in a read only memory (ROM) 602 or a computer program loaded from a storage unit 608 into a random access memory (RAM) 603. In the RAM 603, various programs and data necessary for an operation of the electronic device 600 may also be stored. The computing unit 601, the ROM 602 and the RAM 603 are connected to each other through a bus 604. An input/output (I/O) interface 605 is also connected to the bus 604.

A plurality of components in the electronic device 600 are connected to the I/O interface 605, including: an input unit 606, such as a keyboard, or a mouse; an output unit 607, such as displays or speakers of various types; a storage unit 608, such as a disk, or an optical disc; and a communication unit 609, such as a network card, a modem, or a wireless communication transceiver. The communication unit 609 allows the electronic device 600 to exchange information/data with other devices through a computer network such as Internet and/or various telecommunication networks.

The computing unit 601 may be various general-purpose and/or dedicated processing assemblies having processing and computing capabilities. Some examples of the computing units 601 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 601 executes various methods and steps described above, such as the method of displaying an image. For example, in some embodiments, the method of displaying an image may be implemented as a computer software program which is tangibly embodied in a machine-readable medium, such as the storage unit 608. In some embodiments, the computer program may be partially or entirely loaded and/or installed in the electronic device 600 via the ROM 602 and/or the communication unit 609. The computer program, when loaded in the RAM 603 and executed by the computing unit 601, may execute one or more steps in the method of displaying an image described above. Alternatively, in other embodiments, the computing unit 601 may be configured to perform the method of displaying an image described above by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

A computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of displaying an image, the method comprising:
obtaining an adjusted parameter value in response to a triggering operation of an editing control for a parameter item to be adjusted;
generating a three-dimensional avatar related to a target image, based on the adjusted parameter value, three-dimensional model data, and target image data of the target image;
generating a preview image of the three-dimensional avatar according to the three-dimensional avatar; and
displaying the three-dimensional avatar by using the adjusted parameter value, in response to a determination that a preview effect of the preview image meets an expected effect.

2. The method according to claim 1, further comprising:
in response to a determination that the preview effect of the preview image does not meet the expected effect, repeatedly:
obtaining a new adjusted parameter value in response to the triggering operation of the editing control for the parameter item to be adjusted;
generating a new three-dimensional avatar related to the target image, based on the new adjusted parameter value, the three-dimensional model data, and the target image data of the target image;
generating a new preview image of the new three-dimensional avatar according to the new three-dimensional avatar; and
determining whether the preview effect of the new preview image meets the expected effect or not,
until the preview effect of the new preview image meets the expected effect.

3. The method according to claim 1, further comprising updating, according to the adjusted parameter value, a parameter value corresponding to the parameter item to be adjusted in a parameter configuration file, so as to obtain an updated parameter configuration file, and
wherein the generating a three-dimensional avatar related to a target image, based on the adjusted parameter value, three-dimensional model data, and target image data of the target image comprises processing the three-dimensional model data and the target image data of the target image based on a set of scene function files, so as to generate the three-dimensional avatar related to the target image, wherein the set of scene function files comprises a relevant file for implementing a scene function, and the relevant file comprises the updated parameter configuration file.

4. The method according to claim 3, wherein the generating a preview image of the three-dimensional avatar according to the three-dimensional avatar comprises rendering, by using a rendering engine, the three-dimensional avatar based on the set of scene function files, so as to generate the preview image of the three-dimensional avatar.

5. The method according to claim 1, further comprising determining the preview effect of the preview image according to an evaluation index value of image quality of the preview image, wherein the evaluation index value of image quality comprises at least one selected from: a pixel mean value, a pixel standard deviation, a pixel average gradient, or image entropy.

6. The method according to claim 5, wherein the determining the preview effect of the preview image according to an evaluation index value of image quality of the preview image comprises:
determining that the preview effect of the preview image meets the expected effect, in response to a determination that the evaluation index value of image quality of the preview image falls within an expected evaluation index range; and
determining that the preview effect of the preview image does not meet the expected effect, in response to a determination that the evaluation index value of image quality of the preview image does not fall within the expected evaluation index range.

7. The method according to claim 1, wherein the editing control comprises at least one selected from: an adding control, a modifying control, a deleting control, a sorting control, or a grouping control.

8. The method according to claim 2, further comprising updating, according to the adjusted parameter value, a parameter value corresponding to the parameter item to be adjusted in a parameter configuration file, so as to obtain an updated parameter configuration file, and
wherein the generating a three-dimensional avatar related to a target image, based on the adjusted parameter value, three-dimensional model data, and target image data of the target image comprises processing the three-dimensional model data and the target image data of the target image based on a set of scene function files, so as to generate the three-dimensional avatar related to the target image, wherein the set of scene function files comprises a relevant file for implementing a scene function, and the relevant file comprises the updated parameter configuration file.

9. An electronic device, comprising:
at least one processor; and
a memory communicatively connected to the at least one processor, wherein the memory stores instructions executable by the at least one processor, and the instructions, when executed by the at least one processor, are configured cause the at least one processor to at least:
obtain an adjusted parameter value in response to a triggering operation of an editing control for a parameter item to be adjusted;
generate a three-dimensional avatar related to a target image, based on the adjusted parameter value, three-dimensional model data, and target image data of the target image;
generate a preview image of the three-dimensional avatar according to the three-dimensional avatar; and
display the three-dimensional avatar by using the adjusted parameter value, in response to a determination that a preview effect of the preview image meets an expected effect.

10. The electronic device according to claim 9, wherein the instructions are further configured to cause the at least one processor to at least:
in response to a determination that the preview effect of the preview image does not meet the expected effect, repeatedly:
obtain a new adjusted parameter value in response to the triggering operation of the editing control for the parameter item to be adjusted;
generate a new three-dimensional avatar related to the target image, based on the new adjusted parameter value, the three-dimensional model data, and the target image data of the target image;
generate a new preview image of the new three-dimensional avatar according to the new three-dimensional avatar; and
determine whether the preview effect of the new preview image meets the expected effect or not,
until the preview effect of the new preview image meets the expected effect.

11. The electronic device according to claim 9, wherein the instructions are further configured to cause the at least one processor to at least:
update, according to the adjusted parameter value, a parameter value corresponding to the parameter item to be adjusted in a parameter configuration file, so as to obtain an updated parameter configuration file, and
process the three-dimensional model data and the target image data of the target image based on a set of scene function files, so as to generate the three-dimensional avatar related to the target image, wherein the set of scene function files comprises a relevant file for implementing a scene function, and the relevant file comprises the updated parameter configuration file.

12. The electronic device according to claim 11, wherein the instructions are further configured to cause the at least one processor to at least render, by using a rendering engine, the three-dimensional avatar based on the set of scene function files, so as to generate the preview image of the three-dimensional avatar.

13. The electronic device according to claim 9, wherein the instructions are further configured to cause the at least one processor to at least determine the preview effect of the preview image according to an evaluation index value of image quality of the preview image, wherein the evaluation index value of image quality comprises at least one selected from: a pixel mean value, a pixel standard deviation, a pixel average gradient, or image entropy.

14. The electronic device according to claim 13, wherein the instructions are further configured to cause the at least one processor to at least:
determine that the preview effect of the preview image meets the expected effect, in response to a determination that the evaluation index value of image quality of the preview image falls within an expected evaluation index range; and
determine that the preview effect of the preview image does not meet the expected effect, in response to a determination that the evaluation index value of image quality of the preview image does not fall within the expected evaluation index range.

15. The electronic device according to claim 9, wherein the editing control comprises at least one selected from: an adding control, a modifying control, a deleting control, a sorting control, or a grouping control.

16. A non-transitory computer-readable storage medium having computer instructions therein, wherein the computer instructions are configured to cause a computer system to at least:
obtain an adjusted parameter value in response to a triggering operation of an editing control for a parameter item to be adjusted;
generate a three-dimensional avatar related to a target image, based on the adjusted parameter value, three-dimensional model data, and target image data of the target image;
generate a preview image of the three-dimensional avatar according to the three-dimensional avatar; and
display the three-dimensional avatar by using the adjusted parameter value, in response to a determination that a preview effect of the preview image meets an expected effect.

17. The non-transitory computer-readable storage medium according to claim 16, wherein the instructions are further configured to cause the computer system to at least:
in response to a determination that the preview effect of the preview image does not meet the expected effect, repeatedly:
obtain a new adjusted parameter value in response to the triggering operation of the editing control for the parameter item to be adjusted;
generate a new three-dimensional avatar related to the target image, based on the new adjusted parameter value, the three-dimensional model data, and the target image data of the target image;
generate a new preview image of the new three-dimensional avatar according to the new three-dimensional avatar; and
determine whether the preview effect of the new preview image meets the expected effect or not,
until the preview effect of the new preview image meets the expected effect.

18. The non-transitory computer-readable storage medium according to claim 16, wherein the instructions are further configured to cause the computer system to at least:
update, according to the adjusted parameter value, a parameter value corresponding to the parameter item to be adjusted in a parameter configuration file, so as to obtain an updated parameter configuration file, and
process the three-dimensional model data and the target image data of the target image based on a set of scene function files, so as to generate the three-dimensional avatar related to the target image, wherein the set of scene function files comprises a relevant file for implementing a scene function, and the relevant file comprises the updated parameter configuration file.

19. The non-transitory computer-readable storage medium according to claim 18, wherein the instructions are further configured to cause the computer system to at least render, by using a rendering engine, the three-dimensional avatar based on the set of scene function files, so as to generate the preview image of the three-dimensional avatar.

20. The non-transitory computer-readable storage medium according to claim 16, wherein the instructions are further configured to cause the computer system to at least determine the preview effect of the preview image according to an evaluation index value of image quality of the preview image, wherein the evaluation index value of image quality comprises at least one selected from: a pixel mean value, a pixel standard deviation, a pixel average gradient, or image entropy.
